(19) United States
(12) Patent Application Publication
(10) Pub. No.: US 2004/0001961 A1
(43) Pub. Date: Jan. 1, 2004

(54) Curable resin composition useful for coating, multi-layer printed wiring board, printed wiring board and dry film

(76) Inventors: Takao Ono, Saitama (JP); Tatsuya Kiyota, Saitama (JP); Kentaro Agatsuma, Saitama (JP); Yasuhiro Noda, Saitama (JP)

Correspondence Address: KING & SCHICKLI, PLLC, 247 NORTH BROADWAY, LEXINGTON, KY, 40507, US

(21) Appl. No.: 10/430,745

(22) Filed: May 6, 2003

(30) Foreign Application Priority Data
Jun. 28, 2002 (JP) 2002-189483

(51) Int. Cl. B32B 27/00

(52) U.S. Cl. 428/500

(57) ABSTRACT

Disclosed are a curable resin composition which is capable of forming a low dielectric interlayer insulating material wherein the attenuation of signals due to an enhancement in frequency of circuit can be hardly attenuated, a multi-layer printed wiring board or a printed wiring board each provided with a cured film thereof, and a dry film provided with a semi-cured filmy coating. This curable resin composition comprises a polyfunctional vinylbenzyl ether and a curing promotor. This curable resin composition may further comprise a photosensitive resin, a photopolymerization initiator and a diluent, thus forming a photosensitive/thermosetting resin composition.

This application claims priority to Japanese Patent Application No. 2002-189483, filed Jun. 28, 2002.

### TECHNICAL FIELD

This invention relates to a curable resin composition which is excellent in minimizing dielectric properties as it is employed as an interlayer insulating material for a multi-layer printed wiring board for instance. This invention also relates to a multi-layer printed wiring board where the interlayer insulating film thereof is formed of this curable resin composition, and to a printed wiring board where the solder-resisting film thereof is formed of this curable resin composition. This invention further relates to a dry film which is adapted for use in forming these films.

### BACKGROUND OF THE INVENTION

The printed wiring board is designed to be employed for mounting electronic components by means of soldering on soldering lands of a conductive circuit pattern which has been formed in advance on the substrate of the printed wiring board, wherein all of the circuit regions excluding the soldering lands are covered by a solder-resisting film as a permanent protective film. Due to this covering of solder-resisting film, it becomes possible to prevent the solder from adhering onto regions which are not required to be coated with the solder on the occasion of soldering electronic components to the printed wiring board, and at the same time, to prevent the conductor constituting the circuit pattern from being directly exposed to air and hence from being oxidized or corroded by moisture.

In recent years, due to the increasing demands for the enhancement in density of the printed wiring board, i.e. demands for increasing the number of electronic components to be mounted on a single sheet of printed wiring board concurrent with improvement of surface mounting technique, the employment of a multi-layer printed wiring board is now taken notice of.

The multi-layer printed wiring board is conventionally manufactured as follows. Namely, an interlayer insulating film consisting of an interlayer insulating material is formed at first on the surface of a printed wiring board having a first wiring of a predetermined conductive pattern formed thereon. Then, the printed wiring board is subjected to a nonelectrolytic plating of copper to form a copper layer on which an electrolytic plating of copper is performed to form a plated copper film. Subsequently, the plated copper film is subjected to an exposure and a development with a negative film being superimposed on the copper film to thereby form a second wiring of a predetermined conductive pattern. Thereafter, another interlayer insulating film is deposited over the resultant printed wiring board and another conductive pattern is formed through this interlayer insulating film in the same manner as described above. Thereafter, the same procedures as described above are repeated a required number of times to thereby form multi-layered conductive patterns with an interlayer insulating film being interposed therebetween. Then, the outermost layer of the resultant laminate is perforated by means of drilling or laser to form through-holes for providing an interconnection required between the conductive pattern of the outermost layer and each of the other electronic circuit patterns. Thereafter, the resultant perforated wiring board is subjected to a nonelectrolytic plating of copper to form a copper layer on which an electrolytic plating of copper is performed to form an outermost conductive pattern. This outermost conductive pattern is then treated so as to form a solder-resisting film selectively at the regions necessitating such a resist film, and then, electronic components are secured to the outermost conductive pattern by way of reflow soldering. In this process of manufacturing a multi-layer printed circuit board where the formation of through-holes is required as conventionally practiced, since it is impossible to form the conductive body of conductive pattern at the regions of the wiring board where a through-hole is to be formed in each of the interlayer insulating films, the wiring region of the wiring board would be inevitably restricted. Since there is a limitation in the effort to miniaturize the diameter of the through-hole so as to minimize the effect of this problem, it is recently proposed an attempt to develop multi-layer printed circuit boards where the surface layer thereof is not provided with any through-hole and the inner layers thereof are partially provided with a via (i.e. an interconnecting passageway constituted by a conductive body which is formed on the inner peripheral wall of a through-hole so as to enable a wiring to communicate with another wiring of the underlying layer disposed immediately below), or an attempt to develop multi-layer printed circuit boards where the thickness of the substrate of the printed wiring board or the thickness of each of the interlayer insulating films can be reduced.

As for the method of manufacturing a multi-layer printed wiring board which is provided with the aforementioned via (or via contact), there is proposed a so-called build-up method as explained below. Namely, an interlayer insulating film is at first formed, in the same manner as explained above, on the surface of a printed wiring board having a first wiring of a predetermined conductive pattern formed thereon. Then, a via-hole (i.e. a through-hole communicating with the underlying layer disposed immediately below it) for providing a via contact is formed in this interlayer insulating film by means of laser or drilling. Thereafter, the surface of the resultant printed wiring board is treated using a solution of an oxidizing agent such as a permanganate solution or a dichromate solution (hereinafter simply referred to as “a permanganate solution, etc.”) to roughen the surface of the printed wiring board. Thereafter, the resultant printed wiring board is subjected to a nonelectrolytic plating of copper to form a copper layer on which an electrolytic plating of copper is performed to form a plated copper film. Subsequently, a dry film (an adhesive photosensitive resin film which is semi-cured) is stuck, through the adhesive strength thereof, onto the surface of the plated copper film. Then, the dry film is subjected to an exposure and a development with a negative film (having a conductive pattern of wiring) being superimposed on the dry film to thereby partially expose the plated copper film, the exposed portion of which is then etched away. Thereafter, the dry film that has been cured by the aforementioned exposure is removed by making use of a dilute alkaline solution to form a second conductive pattern. Thereafter, another interlayer insulating film is deposited over the resultant printed wiring board and another conductive pattern is formed through this interlayer insulating film in the same manner as described above. Thereafter, the same procedures as described above are repeated a required number of times to thereby form an electronic circuit wherein the multi-layered conductive patterns are interconnected with each other with an interlayer insulating film being interposed therebetween. The outermost conductive pattern is then treated so as to form a solder-resisting film selectively at the regions necessitating such a resist film, and then, electronic components are secured to the outermost conductive pattern by way of reflow soldering as usually performed.

According to this build-up method, since the via-hole is merely constituted by a through-hole which is simply enabled to communicate with the underlying layer disposed immediately below it, it becomes possible to form a via contact of relatively small diameter and there is relatively a little possibility that the wiring region is narrowed. Therefore, this build-up method is advantageous in the respect that electronic components can be mounted on a wiring board at a high density.

On the other hand, the frequency of circuits to be employed in computer machines and the peripheral devices thereof as well as in digital communication instruments, such as the clock frequency of CPU for instance, is now becoming increasingly higher concurrent with the improvement of performance of these machines and devices. For example, the frequency of circuits in consumer-electronics products is now already increased higher than 1 GHz. In the case of potable telephones and movable communication instruments which are remarkably popularized now, a high-frequency band is allotted for them in order to avoid the frequency zones which are now being used or in order to secure a large number of channels.

Under the circumstances, the electronic instruments having a high-frequency circuit mounted thereon is now increasingly employed, so that the multi-layer printed circuit board is also required to have properties so as to enable it cope with such electronic instruments provided with such a high-frequency circuit.

Generally, the propagation velocity and attenuation of signals due to an increase in frequency can be calculated from the relative permittivity and dielectric loss tangent of a printed circuit board, etc. Namely;

Propagation velocity: V=C/εᵣ^{1/2}

Attenuation: a=(f×εᵣ^{1/2}×tan δ)/C

(wherein C is light velocity; εᵣ is a relative permittivity; f is a frequency; and tan δ is a dielectric loss tangent)

It will be recognized from the above formulas that when it is desired to minimize the attenuation of signals, not only the relative permittivity but also the dielectric loss tangent should be minimized in order to increase the operating frequency.

However, when a thermosetting epoxy resin which is curable by simply making use of a curing agent such as imidazole, dicyanamide, etc. is to be employed as an interlayer insulating material according to the conventional method in the manufacture of a multi-layer printed wiring board as described above, there is a problem that, since the manufacture of a multi-layer printed wiring board involves the steps of: forming a via-hole in an interlayer insulating film, treating the surface of the resultant printed wiring board with a permanganate solution, for example, to roughen the surface of the printed wiring board, and successively depositing a nonelectrolytically plated copper film and an electrolytically plated copper film to form a plated copper laminate, it would be impossible, with the cured film of this epoxy resin, to prevent the relative permittivity and the dielectric loss tangent from increasing. Therefore, the aforementioned thermosetting epoxy resin is not suited for use as a material for a multi-layer printed wiring board having a high-frequency circuit mounted thereon.

In an attempt to minimize the relative permittivity of the printed wiring board, various kinds of resins such as fluorinated resin, polyphenylene ether resin, epoxy-modified polyphenylene ether resin and polyvinylbenzyl ether resin have been proposed in recent years for using them in a high-frequency band. However, all of these resins are intended not to be used as an interlayer insulating material for a multi-layer printed wiring board but to be used as a molding material or as an impregnating material. Therefore, if these resins are to be employed as an interlayer insulating material for a multi-layer printed wiring board, it is necessary to re-examine them in specific viewpoints as an interlayer insulating material, i.e. with respect to the workability thereof in the aforementioned surface-roughening treatment using a permanganate solution, etc., the adhesivity thereof to a plated copper film, and the reliability of insulating property thereof between layers.

Therefore, a first object of the present invention is to provide a curable resin composition useful for coating, which is excellent in minimizing not only the dielectric constant but also the dielectric loss tangent thereof. This invention is also aimed at providing a multi-layer printed wiring board, providing a printed wiring board, and providing a dry film, all of which are to be obtained by making use of the aforementioned curable resin composition.

A second object of the present invention is to provide a curable resin composition useful for coating, which is excellent not only in workability but also in adhesivity to a plated copper film, thus making the copper film difficult to peel off. This invention is also aimed at providing a multi-layer printed wiring board, providing a printed wiring board, and providing a dry film, all of which are to be obtained by making use of the aforementioned curable resin composition.

A third object of the present invention is to provide a curable resin composition useful for coating, which is capable of forming a film which makes it possible to provide a surface layer or an inner layer having simply a via contact without necessitating the provision of a through-hole in these layers. This invention is also aimed at providing a multi-layer printed wiring board, providing a printed wiring board, and providing a dry film, all of which are to be obtained by making use of the aforementioned curable resin composition.

A fourth object of the present invention is to provide a curable resin composition useful for coating, which is capable of achieving the aforementioned objects and at the same time, capable of forming a film which does not badly affect the exposure, development and other characteristics in the working process thereof. This invention is also aimed at providing a multi-layer printed wiring board, providing a printed wiring board, and providing a dry film, all of which are to be obtained by making use of the aforementioned curable resin composition.

A fifth object of the present invention is to provide a curable resin composition useful for coating, which can be used also as an adhesive or as a material for a printing plate. This invention is also aimed at providing a dry film that can be obtained by making use of the aforementioned curable resin composition.

### BRIEF SUMMARY OF THE INVENTION

The present inventors have found, as a result of intensive studies for achieving the aforementioned objects, that a cured film formed of a specific compound represented by the following general formula (1) is effective in achieving the aforementioned objects, thus accomplishing the present invention.

Namely, according to the present invention, there is provided (1) a curable resin composition useful for coating, which comprises (A) a polyfunctional vinylbenzyl ether represented by the following general formula (1), and (B) a curing promotor.

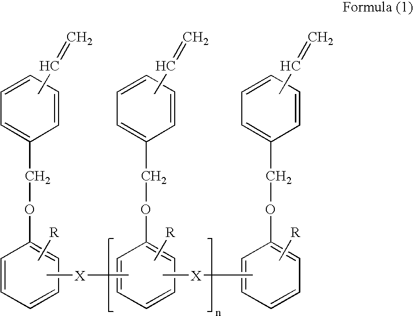

(wherein X denotes —CH₂— or a group represented by the following chemical formula (2); R denotes H or CH₃, wherein Rs each included as a substituent in benzene ring may be the same or different from each other; and n is 0 or an integer larger than 0)

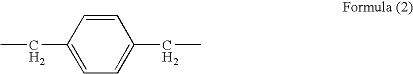

According to the present invention, there is also provided (2) a curable resin composition useful for coating, which comprises (A) a polyfunctional vinylbenzyl ether represented by the aforementioned general formula (1), (D) a thermosetting epoxy resin, (E) an epoxy-curable compound, (G) a photopolymerization initiator, and (H) a diluent.

According to the present invention, there is also provided (3) the curable resin composition useful for coating as set forth in the aforementioned item (1), wherein said curing promotor (B) is incorporated at a ratio of 0.01 to 10 g per 100 g of said polyfunctional vinylbenzyl ether (A).

According to the present invention, there is also provided (4) a multi-layer printed wiring board which is provided with an interlayer insulating film formed of a cured film which is constituted by the curable resin composition useful for coating as set forth in any one of the aforementioned items (1) to (3).

According to the present invention, there is also provided (5) a printed wiring board which is provided with a solder-resisting film formed of a cured film which is constituted by the curable resin composition useful for coating as set forth in any one of the aforementioned items (1) to (3).

According to the present invention, there is also provided (6) a dry film which is constituted by a semi-cured filmy coating which is obtained by the coating of the curable resin composition useful for coating as set forth in any one of the aforementioned items (1) to (3) on a substrate film.

### DETAILED DESCRIPTION OF THE INVENTION

As for “a polyfunctional vinylbenzyl ether represented by the aforementioned general formula (1)” according to the present invention, it is possible to employ those wherein the molecule thereof includes at least two (two or more) vinylbenzyl ether groups which are bonded to an aromatic residual group (a residual group to be derived by eliminating hydroxyl group from a polyhydric phenol compound), specific examples of this aromatic residual group including polyhydric phenol compounds such as phenolic novolac, cresol novolac, etc. In this general formula (1), n is 0 or an integer larger than 0, so that if n=0, the compound is constituted by a couple of vinylbenzyl ether groups. Preferably, this n should be an integer of 2 or more, and if the compounds represented by this general formula (1) are to be employed as a resin component for the curable resin composition useful for coating, this n should be confined within the range of 3 to 7 in view of facilitating the manufacture of this resin composition, enhancing the workability in using it such as coating property thereof and improving the easiness in handling this resin composition. If this n is increased beyond 10, i.e. if this compound represented by the general formula (1) is constituted by a high-molecular weight compound having a weight average molecular weight of more than 100,000, the resultant resin composition may be deteriorated in defoaming property thereof in the coating thereof, thus possibly permitting voids to be left remain in the resultant filmy coating thereof.

These specific compounds can be easily produced, as known in the art, through a dehydrochlorination reaction by making use of an inorganic alkali, wherein chloromethyl styrene and a polyhydric phenol compound are employed as main raw materials, and dimethyl sulfoxide is employed as a solvent.

As for the curing promotor (B) to be employed in the present invention, there is not any particular limitation, and therefore, it is possible to employ an organic peroxide such as benzoyl peroxide, ketone peroxide, peroxyketal, hydroperoxide, dialkyl peroxide, diacyl peroxide, peroxycarbonate, peroxyester, etc.; cationic polymerization initiator; other redox polymerization initiator; and other radical polymerization initiator.

Among them, t-butyl peroxybenzoate (“Perbutyl Z”, Nippon Oil & Fats Co., Ltd.), 1,1-bis(t-butylperoxy)-3,3,5-trimethyl cyclohexane (“Perhexa 3M”, Nippon Oil & Fats Co., Ltd.), “Adeca Optomer CP-66” (Asahi Denka Co., Ltd.), “Adeca Optomer CP-77” (Asahi Denka Co., Ltd.), “Sun Aid SI” (Sanshin Chemical Industry, Ltd.), and “CI-2639” (Nippon Soda Co., Ltd.) are capable of achieving the low temperature curing of the curable resin composition or enabling the polyfunctional vinylbenzyl ether (A) to take place the radical polymerization thereof, thus making it possible to obtain a cured film having an enhanced strength.

These compounds useful as a curing promotor (B) may be employed singly or in combination of two or more kinds thereof. The quantity of this curing promotor (B) in the resin composition may be generally confined within the range of 0.01 to 10 g per 100 g of the polyfunctional vinylbenzyl ether (A). If the quantity of this curing promotor (B) is less than 0.01 g, it may become difficult to permit the curing reaction of the resin composition comprising the aforementioned components (A) and (B) to proceed through a radical polymerization thereof, and moreover, it is difficult to enable the resultant cured film to improve the heat resistance, solvent resistance and insulation resistance. On the other hand, if the quantity of this curing promotor (B) exceeds over 10 g, the curing reaction of the resin composition by way of radical polymerization may be permitted to proceed excessively, thus increasing the density of crosslinking, resulting in that the surface roughening of the cured film by making use of the aforementioned permanganate solution can not be proceeded sufficiently, thus deteriorating the adhesive strength of the plated copper film.

The curable resin composition useful for coating according to the present invention may include, in addition to the aforementioned components (A) and (B), a copolymerizable monomer (C) for the purpose of minimizing the dielectric properties of the cured film and of improving the radical polymerization reactivity. Specific examples of such a copolymerizable monomer (C) include styrene, vinyl toluene, divinyl benzene, divinylbenzyl ether, allyl phenol, allyl oxybenzene, diallyl phthalate, acrylic ester, methacrylic ester, vinylpyrrolidone, vinylbenzyl-n-butylether, vinylbenzyl-sec-butylether, vinylbenzyl-n-hexylether, vinylbenzyl-iso-hexylether, vinylbenzyl-sec-hexylether, vinylbenzyl-n-octylether, vinylbenzyl-(2-ethylhexyl) ether, vinylbenzyl methallylether, vinylbenzyl-(β-methoxymethyl)ether, vinylbenzyl-(n-butoxypropyl) ether, vinylbenzyl benzylether, vinylbenzyl phenylmethyl carbinylether, vinylbenzyl cyclohexylether, vinylbenzyl dicyclopentenyl methylether, etc. These monomers may be employed singly or in combination of two or more kinds thereof. The quantity of these monomers in the resin composition may be generally confined within the range of 0 to 50 g per 100 g of the polyfunctional vinylbenzyl ether (A). If the quantity of these monomers exceeds over 50 g, it may become difficult to enable the resultant cured film of the resin composition comprising the aforementioned components (A) to (C) to improve the heat resistance, solvent resistance and insulation resistance.

The curable resin composition useful for coating according to the present invention may include, in addition to the aforementioned components (A) and (B) and to the aforementioned component (C) which may be added as required, a thermosetting epoxy resin (D) and an epoxy-curable compound (E) for the purpose of improving the heat resistance of the cured film. As for the thermosetting epoxy resin (D) useful in this case, there is not any particular limitation. For example, it is possible to employ, as the thermosetting epoxy resin (D), epoxy resin (including epoxy oligomer) which contains at least one epoxy group, preferably two or more epoxy groups per molecule for instance. Specific examples of the thermosetting epoxy resin (D) includes for example bisphenol A epoxy resin, bisphenol F epoxy resin, bisphenol S epoxy resin, phenol novolac type epoxy resin, cresol novolac type epoxy resin, bisphenol A novolac type epoxy resin, bisphenol F novolac type epoxy resin, alicyclic epoxy resin, glycidyl ester type epoxy resin, glycidyl amine type epoxy resin, biphenyl type epoxy resin; hydantoin type epoxy resin, isocyanulate type epoxy resin, aliphatic cyclic type epoxy resins, etc. It is also possible to employ a brominated type of each of the aforementioned epoxy resins such as brominated bisphenol A epoxy resin which is designed to improve the nonflammability of cured film. These thermosetting resins may be employed singly or in combination of two or more kinds thereof.

Among these thermosetting resins, bisphenol A epoxy resin (for example, “Epichlon 1050”, Dainippon Ink & Chemicals Inc.), biphenyl type epoxy resin (for example, “YX-4000”, the trade name of 2,6-xylenol dimmer diglycyzyl ether available from Yuka Shell Epoxy Kabushikikaisha), and alicyclic epoxy resin (for example, “EHPE-3150”, the trade name of 1, 2-epoxy-4-(2-oxiranyl) cyclohexane adduct of 2,2-bis(hydroxymethyl)-1-butanol available from DAICEL Chemical Industries Ltd.) are particularly useful, when used together with the aforementioned components (A) and (B) as well as with the aforementioned component (C), in densely forming an island structure after the surface roughening treatment of the cured film by making use of permanganate solution and in obtaining a plated metal film excellent in adhesion.

The quantity of these epoxy resins in the resin composition may be generally confined within the range of 0 to 50 g per 100 g of the polyfunctional vinylbenzyl ether (A). If the quantity of these monomers exceeds over 50 g, it would become impossible to prevent the relative permittivity and the dielectric loss tangent of the cured film from increasing and therefore, it may become difficult to enable the resultant cured film to comply with the high-frequency circuit.

As for the epoxy-curable compound (E) to be employed for curing the aforementioned thermosetting epoxy resin (D), it is possible to employ bisphenol A, bisphenol F, polyvinyl phenol, phenol novolac resin, bisphenol A novolac resin, phenol novolac resin having triazine structure in the molecule thereof, a dicyandiamide-based compound, imidazole-based resin, etc. These compounds may be employed singly or in combination of two or more kinds thereof.

In particular, it is preferable to employ, as the epoxy-curable compound (E), a dicyandiamide-based compound such as dicyandiamide and the derivatives thereof. Specific examples of this dicyandiamide-based compound include, for example, N-substituted dicyandiamide derivatives having, as the substituent group thereof, a linear or branched alkyl group having 1-12 carbon atoms, or aryl group or aralkyl group such as phenyl group, benzyl group, phenethyl group, 3-phenylpropyl group and 4-phenylbutyl group (these groups may contain at least one kind of groups selected from lower alkyl groups having 1-3 carbon atoms, lower alkoxyl groups having 1-3 carbon atoms, hydroxyl group, amino group and lower alkyl-substituted amino groups having 1-4 carbon atoms) (i.e. those described in Japanese Patent Unexamined Publication (Kokai) H11-119429 as the general formulas and specific examples of dicyandiamide-based compounds); and organic acid salts of dicyandiamide and of the derivatives thereof (for example, lactate, phthalate, trimellitate or other polybasic carboxylates); phosphates of dicyandiamide and of the derivatives thereof; substituted organic phosphates (wherein a couple of hydrogen atoms thereof are substituted by at least one kind of groups selected from a linear or branched alkyl group having 1-9 carbon atoms, aliphatic cyclic hydrocarbon groups, and acryloyl or methacryloyl groups) of dicyandiamide and of the derivatives thereof; sulfates of dicyandiamide and of the derivatives thereof; and substituted organic sulfates (wherein one of hydrogen atoms thereof is substituted by alkyl group having 1-18 carbon atoms or aromatic groups) of dicyandiamide and of the derivatives thereof (i.e. those described in Japanese Patent Application 2000-277430 as the general formulas and specific examples of dicyandiamide-based compounds).

The quantity of this epoxy-curable compound (E) in the resin composition may be generally confined within the range of 0.01 to 100 g per 100 g of the thermosetting epoxy resin (D). If the quantity of this epoxy-curable compound (E) is less than 0.01 g, it may become difficult to permit the thermal curing reaction of the resin composition comprising the aforementioned thermosetting epoxy resin (D) to proceed, and moreover, it is difficult to enable the resultant cured film to improve the heat resistance, solvent resistance and insulation resistance. On the other hand, if the quantity of this epoxy-curable compound (E) exceeds over 100 g, the density of crosslinking of the cured film may be caused to increase, resulting in that the surface roughening of the cured film by making use of the aforementioned permanganate solution can not be proceeded sufficiently, thus deteriorating the adhesive strength of the plated metal film or increasing the relative permittivity and the dielectric loss tangent of the cured film and therefore, it may become difficult to enable the resultant cured film to comply with the high-frequency circuit.

It is preferable in the present invention to employ a curable resin composition useful for coating, which includes the aforementioned components (A) and (B) and also optionally, the aforementioned components (C), (D), (E) and an organic solvent to be incorporated as required as explained hereinafter. However, it is also possible in the present invention to employ a curable resin composition useful for coating, which further contains, in addition to the aforementioned components (A) and (B) and the aforementioned optional components (C), (D), (E) and organic solvent which are to be incorporated as required, “an active energy line (ray)-curable resin having at least two ethylenic unsaturated linkages per molecule thereof (F)” as part of the component (A) or at a ratio which is preferably at most equal in weight to the component (A), i.e. at a ratio of 0 to the same weight as that of the component (A), it is also possible to employ “a photopolymerization initiator (G)” together with the aforementioned component (B) or at a ratio substituting part of all of the component (B) in a photosensitive thermosetting resin composition according to the present invention, which may also contain “a diluent (H)”. All of the thermosetting resin compositions mentioned above can be suitably employed as an interlayer insulating material for a multi-layer printed wiring board or as a solder resist composition for manufacturing a printed wiring board.

As for “an active energy line curable resin having at least two ethylenic unsaturated linkages in one molecule (F)”, it is possible to employ those which can be obtained by a process wherein at least part of epoxy groups of multifunctional epoxy resin having at least two epoxy groups per molecule thereof is allowed to react with a radically polymerizable unsaturated monocarboxylic acid such as acrylic acid or methacrylic acid to produce a compound having hydroxyl group with which a polybasic acid or a polybasic acid anhydride is reacted to obtain the aforementioned active energy line curable resin. By the way, with regard to the resins to be employed in the present invention, this component (F) is a broader term including therein the concept of the aforementioned component (A).

As for the aforementioned multifunctional epoxy resin, it is possible to employ any kinds of epoxy resin as long as it is at least bifunctional, and there is not any particular limitation with regard to the epoxy equivalent thereof, which may be generally 1,000 or less, more preferably 100 to 500.

For example, it is possible to employ phenol novolac type epoxy resins such as bisphenol A, bisphenol F and bisphenol AD; cresol novolac type epoxy resins such as o-cresol novolac type epoxy resins; bisphenol A novolac type epoxy resins; cyclic aliphatic multifunctional epoxy resin; glycidyl ester type multifunctional epoxy resin; glycidyl amine type multifunctional epoxy resin; heterocyclic multifunctional epoxy resin; bisphenol modified novolac type epoxy resins; multifunctional modified novolac type epoxy resins; and condensed type epoxy resin formed between phenols and aromatic aldehyde having a phenolic hydroxyl group. It is also possible to employ those where a halogen atom such as Br, Cl, etc. is introduced into these resins mentioned above. Among them, novolac type epoxy resins are preferable in terms of heat resistance. These epoxy resins may be employed singly or in combination of two or more kinds thereof.

When these epoxy resins are then reacted with a radically polymerizable unsaturated monocarboxylic acid, epoxy group is cleaved through the reaction between epoxy group and carboxylic group to thereby generate hydroxyl group and ester linkage. As for the radically polymerizable unsaturated monocarboxylic acid useful in this case, there is not any particular limitation. For example, it is possible to employ acrylic acid, methacrylic acid, crotonic acid, cinnamic acid, etc. However, it is preferable to employ at least either acrylic acid or methacrylic acid (which may be hereinafter referred to as (metha)acrylic acid), acrylic acid being most preferable. There is not any particular limitation regarding the reacting method between the epoxy resin and the radically polymerizable unsaturated monocarboxylic acid. For example, these epoxy resin and acrylic acid can be reacted by heating them in a suitable diluent. As for the diluent, it is possible to employ ketones such as methylethyl ketone, cyclohexanone, etc.; aromatic hydrocarbons such as toluene, xylene, etc.; alcohols such as methanol, isopropanol, cyclohexanol, etc.; alicyclic hydrocarbons such as cyclohexane, methylcyclohexane, etc.; petroleum solvents such as petroleum ether, petroleum naphtha, etc.; Cellosolves such as Cellosolve, butyl Cellosolve, etc.: carbitols such as carbitol, butyl carbitol, etc.; and acetic esters such as ethyl acetate, butyl acetate, Cellosolve acetate, butyl Cellosolve acetate, carbitol acetate, butylcarbitol acetate, etc. As for the catalyst to be employed in this case, it is possible to employ amines such as triethyl amine, tributyl amine, etc.; and phosphides such as triphenyl phosphine, triphenyl phosphate, etc.

In the reaction between the aforementioned epoxy compounds and the radically polymerizable unsaturated monocarboxylic acid, it is preferable that the radically polymerizable unsaturated monocarboxylic acid should preferably be employed at a ratio of 0.7 to 1.2 equivalent weight per equivalent weight of epoxy group contained in the epoxy compounds. If at least either acrylic acid or methacrylic acid is to be employed for the reaction, it should preferably be employed at a ratio of 0.8 to 1.0 equivalent weight per equivalent weight of epoxy group contained in the epoxy compounds. If the ratio of the radically polymerizable unsaturated monocarboxylic acid is less than 0.7 equivalent weight, the gellation may be caused to occur on the occasion of a subsequent step of synthesizing reaction, or otherwise the stability of the resin may be deteriorated. On the other hand, if the ratio of the radically polymerizable unsaturated monocarboxylic acid is excessive, a lot of unreacted carboxylic acid may be caused to remain, so that the various properties of cured matter (for example, water proofness) may be caused to deteriorate. The reaction between these epoxy resins and the radically polymerizable unsaturated monocarboxylic acid should preferably be performed under a heated condition, wherein the reaction temperature should preferably be within the range of 80 to 140° C. If the reaction temperature is higher than 140° C., the thermal polymerization of the radically polymerizable unsaturated monocarboxylic acid may be easily caused to take place, thereby making it difficult to perform the synthesizing reaction. If the reaction temperature is lower than 80° C., the reaction rate may become too slow, thereby making it undesirable in a practical manufacturing viewpoint.

In the reaction between the aforementioned epoxy compounds and the radically polymerizable unsaturated monocarboxylic acid in a diluent, the content of the diluent should preferably be confined within the range of 20 to 50% based on the entire weight of the reaction system. In this case, the reaction mixture can be presented, as a solution in the diluent, i.e. without necessitating the isolation of the reaction product between the aforementioned epoxy compounds and the radically polymerizable unsaturated monocarboxylic acid, to the next step where the reaction product is reacted with a polybasic acid. By the way, “%” in the present invention means “mass %” An unsaturated monocarboxylic acid-modified epoxy compound which is a reaction product between the aforementioned epoxy compounds and the radically polymerizable unsaturated monocarboxylic acid is then allowed to react with a polybasic acid or the anhydride thereof (or with both of polybasic acid and the anhydride thereof). As for the polybasic acid or the anhydride hereof, there is not any particular limitation, and therefore, it may be a saturated or unsaturated polybasic acid or anhydride thereof. As for the polybasic acid useful in this case, it is possible to employ succinic acid, maleic acid, adipic acid, citric acid, phthalic acid, tetrahydrophthalic acid, 3-methyltetrahydrophthalic acid, 4-methyltetrahydrophthalic acid, 3-ethyltetrahydrophthalic acid, 4-ethyltetrahydrophthalic acid, hexahydrophthalic acid, 3-methylhexahydrophthalic acid, 4-methylhexahydrophthalic acid, 3-ethylhexahydrophthalic acid, 4-ethylhexahydrophthalic acid, methyltetrahydrophthalic acid, methylhexahydrophthalic acid, endomethylenetetrahydrophthalic acid, methylendomethylenetetrahydrophthalic acid, trimellitic acid, pyromellitic acid, and diglycolic acid. As for the polybasic acid anhydride, it is possible to employ anhydrides of these polybasic acids. These compounds can be employed singly or in combination of two kinds thereof.

The polybasic acid or the anhydride thereof is then allowed to react with the hydroxyl group that has been generated from the reaction between the aforementioned epoxy compounds and the radically polymerizable unsaturated monocarboxylic acid, thereby providing the resin having carboxyl group bonded thereto. The quantity to be employed of the polybasic acid or anhydrides thereof for the reaction should preferably be confined within the range of 0.2 to 1.0 moles per mole of the hydroxyl group attached to the reaction product obtained through the reaction between the aforementioned epoxy compounds and the radically polymerizable unsaturated monocarboxylic acid. It is more preferable, in view of enabling a resin film to obtain a high sensitivity on the occasion of exposure, to perform the reaction by confining the ratio of the polybasic acid or anhydrides thereof to 0.3 to 0.9 mole, more preferably 0.4 to 0.8 mole per mole of the hydroxyl group. If the ratio of the polybasic acid or anhydrides thereof is less than 0.2 mole, the dilute alkali developing property of the resin to be ultimately obtained would be deteriorated. On the other hand, if the ratio of the polybasic acid or anhydrides thereof exceeds over 1.0 moles, various properties (for example, waterproofness) of the cured filmy coating to be ultimately obtained would be deteriorated.

The polybasic acid is added to the aforementioned unsaturated monocarboxylic acid-modified epoxy resin so as to allow a dehydrocondensation reaction to take place. The water that has been generated in this reaction should preferably be continuously taken out of the reaction system. It is preferable that this reaction is performed under a heated condition at a temperature of 70-130° C. If the reaction temperature is higher than 130° C., the thermal polymerization of the radically polymerizable unsaturated groups that have been bonded to the epoxy resin or that can be derived from unreacted monomer may be easily caused to take place, thereby making it difficult to perform the synthesis. On the other hand, if this reaction temperature is lower than 70° C., the speed of reaction would become too slow and therefore is not preferable in view of the actual manufacturing process. These reaction conditions mentioned above are also applicable when an anhydride of the polybasic acid is to be employed.

The acid value of the polybasic acid-modified unsaturated monocarboxylic acid-modified epoxy resin to be produced through the reaction between the aforementioned polybasic acid or anhydride thereof and the unsaturated monocarboxylic acid-modified epoxy resin should preferably be within the range of 60 to 300 mgKOH/g. The acid value of the reaction product can be adjusted by adjusting the quantity of the polybasic acid or anhydride thereof to be used in the reaction.

Although the aforementioned polybasic acid-modified unsaturated monocarboxylic acid-modified epoxy resin can be also employed as a photosensitive resin, a radically polymerizable unsaturated group may be further introduced into this epoxy resin through a reaction between the carboxyl group of this polybasic acid-modified unsaturated monocarboxylic acid-modified epoxy resin and a glycidyl compound having at least one radically polymerizable unsaturated group and epoxy group, thereby obtaining a photosensitive resin which is further improved in photosensitivity.

Since this photosensitive resin which is further improved in photosensitivity is featured in that the radically polymerizable unsaturated group is bonded to the side chain of the polymeric skeleton of the photosensitive resin constituting the precursor thereof due to the last reaction thereof with the glycidyl compound, the photopolymerization reactivity thereof is further enhanced, thus exhibiting excellent photosensitive properties. As for the glycidyl compound having at least one radically polymerizable unsaturated group and epoxy group, it is possible to employ glycidyl acrylate, glycidyl methacrylate, allyl glycidyl ether, pentaerythritol triacrylate monoglycidyl ether, etc. By the way, the molecule of these compounds may contain a plurality of glycidyl groups. These compounds may be employed singly or in combination of two or more kinds thereof.

These glycidyl compounds can be mixed into a solution of the polybasic acid-modified unsaturated monocarboxylic acid-modified epoxy resin so as to allow the reaction thereof to take place. In this case, the reaction is executed by incorporating the glycidyl compound to the solution generally at a ratio of 0.05-0.5 mole per mole of the carboxyl group that has been introduced into the epoxy resin. In view of various factors such as the photosensitivity (sensitivity) of the photosensitive resin composition containing a photosensitive resin that can be obtained, the aforementioned heat control tolerance (controllable range of the thermal permissible limit of curing degree which enables unexposure portions of filmy coating to be removed by means of development when the filmy coating is dried), and the electric properties such as electric insulation, it would be more advantageous to execute the reaction by incorporating the glycidyl compound at a ratio of 0.1-0.5 mole per mole of the carboxyl group. The reaction temperature in this case should preferably be within the range of 80-120° C. The acid value of the photosensitive resin which is composed of this glycidyl compound-added polybasic acid-modified unsaturated monocarboxylic acid-modified epoxy resin should preferably be within the range of 45-250 mgKOH/g.

The aforementioned component (D) should preferably be added to the resin composition at a ratio of 5 to 100 g per 100 g of the aforementioned component (F). If the content of the component (D) is less than 5 g, it may become impossible to obtain a filmy coating having desirable properties which are expected to be obtained after the heat-curing or so-called post curing thereof subsequent to the photo-curing thereof. On the other hand, if the content of the component (D) exceeds over 100 g, the photo-curability of the component (F) may be deteriorated. It is preferable, in terms of the properties of filmy coating after the post-curing thereof and of the photo-curability of the component (F), to confine the quantity of the component (D) to 15 to 60 g per 100 g of the aforementioned component (F).

As for the photopolymerization initiator (G), there is not any particular limitation and hence any known materials can be employed. Representative examples thereof include benzoin, benzoin methyl ether, benzoin ethyl ether, benzoin isopropyl ether, benzoin-n-butyl ether, benzoin isobutyl ether, acetophenone, dimethylamino acetophenone, 2,2-dimethoxy-2-phenyl acetophenone, 2,2-diethoxy-2-phenyl acetophenone, 2-hydroxy-2-methyl-1-phenylpropan-1-one, 1-hydroxycyclohexylphenyl ketone, 2-methyl-1-[4-(methylthio)phenyl]-2-morpholino-propan-1-one, 4-(2-hydroxyethoxy)phenyl-2-(hydroxyl-2-propyl) ketone, benzophenone, p-phenyl benzophenone, 4,4′-diethylamino benzophenone, dichloro benzophenone, 2-methylanthraquinone, 2-ethylanthraquinone, 2-tertiary butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyldimethyl ketal, acetophenone dimethyl ketal, p-dimethylamino benzoic ethylester, etc. these compounds can be employed singly or in combination of two or more kinds thereof.

The mixing ratio of the photopolymerization initiator (G) may be generally in the range of 0.5-50 g based on 100 g of the active energy line-curable resin constituting the component (F). If the mixing ratio of the photopolymerization initiator is less than 0.5 g, it would become difficult to enable the active energy line-curable resin to proceed the photo-curing reaction thereof. On the other hand, even if the mixing ratio of the photopolymerization initiator is increased exceeding over 50 g, it is impossible to further enhance the effects expected of the photopolymerization initiator, and hence an excessive addition of the photopolymerization initiator is economically disadvantageous. Furthermore, any excessive addition of the photopolymerization initiator may invite the deterioration of the mechanical properties of the cured film thereof. In viewpoints of the photo-curing properties, economy and mechanical properties of cured film, the mixing ratio of the photopolymerization initiator should preferably be in the range of 2.0-30 g based on 100 g of the active energy line-curable resin.

The diluent (H) is constituted by at least one kind of materials selected from a photo-polymerizable monomer and an organic solvent. This photo-polymerizable monomer is also called a reactive diluent and is designed to be employed for promoting the photo-curing of the active energy line-curable resin (photosensitive resin) constituting the component (F) and for obtaining a filmy coating which is excellent in acid resistance, heat resistance and alkali resistance. Preferably, the photo-polymerizable monomer should be selected from compounds having at least two double bonds in each molecule. An organic solvent may be employed for the purpose of adjusting the viscosity and drying property of the photosensitive/thermosetting resin composition useful for coating and comprising a photosensitive resin constituting the aforementioned component (F). However, the organic solvent may not be employed if the employment thereof is not required. Further, if the photo-curability of the photosensitive resin constituting the aforementioned component (F) is sufficiently large in magnitude, the photo-polymerizable monomer may not be employed.

As for the specific examples of the reactive diluent, it is possible to employ, for example, 1,4-butanediol di(metha)acrylate, 1,6-hexanediol di(metha)acrylate, neopentylglycol di(metha)acrylate, polyethyleneglycol di(metha)acrylate, neopentylglycol diadipate di(metha)acrylate, hydroxyl-pivalic acid neopentylglycol di(metha)acrylate, dicyclopentanyl di(metha)acrylate, caprolactone-modified dicyclopentenyl di(metha)acrylate, ethylene oxide-modified phosphoric acid di(metha)acrylate, allylcyclohexyl di(metha)acrylate, isocyanurate di(metha)acrylate, trimethylolpropane tri(metha)acrylate, dipentaerythritol tri(metha)acrylate, propionic acid-modified dipentaerythritol tri(metha)acrylate, pentaerythritol tri(metha)acrylate, propylene oxide-modified trimethylolpropane tri(metha)acrylate, tris(acryloxyethyl)isocyanurate, propionic acid-modified dipentaerythritol penta(metha)acrylate, dipentaerythritol hexa(metha)acrylate, caprolactone-modified dipentaerythritol hexa(metha)acrylate, etc.

The aforementioned 2- to 6-functional as well as other polyfunctional reactive diluents may be employed singly or in combination of two or more kinds. The mixing ratio of these reactive diluents may be selected generally from the range of 2.0 to 40 g per 100 g of the active energy line-curable resin constituting the component (F). If the mixing ratio of these reactive diluents is less than 2.0 g, it would be impossible to achieve a sufficient photo-curing and to obtain satisfactory properties in terms of acid resistance and heat resistance of the film cured of the photosensitive/thermosetting resin composition useful for coating according to the present invention. On the other hand, even if the mixing ratio of these reactive diluents is increased exceeding over 40 g, the cured film thereof would become excessively high in tackiness, thereby easily generating the adhesion of the cured film onto the substrate of art work film in the step of exposure, thus making it difficult to obtain a cured film which is aimed at.

In view of various factors such as photo-curing property, the acid resistance and heat resistance of cured film, and the prevention of adhesion onto the substrate of art work film, the mixing ratio of the reactive diluent should more preferably be within the range of 4.0 to 20 g per 100 g of the active energy line-curable resin.

As for the specific examples of the aforementioned organic solvent useful in this case, they include ketones such as methylethyl ketone, cyclohexanone, etc.; aromatic hydrocarbons such as toluene, xylene, etc.; alcohols such as methanol, isopropanol, cyclohexanol, etc.; alicyclic hydrocarbons such as cyclohexane, methylcyclohexane, etc.; petroleum solvents such as petroleum ether, petroleum naphtha, etc.; Cellosolves such as Cellosolve, butyl Cellosolve, etc.; carbitols such as carbitol, butyl carbitol, etc.; and acetic esters such as ethyl acetate, butyl acetate, Cellosolve acetate, butyl Cellosolve acetate, carbitol acetate, butylcarbitol acetate, etc.

The photosensitive resin composition according to the present invention may further contain, if desired for the purpose of enhancing the coefficient of linear expansion and the heat resistance, various kinds of additives in addition to the aforementioned components, specific examples of such additives including a filler consisting of inorganic pigment(s) such as fused silica, crystalline silica, calcium carbonate, alumina (aluminum hydroxide), clay, barium sulfate, mica, talc, E-glass fine powder, etc. These inorganic pigments may be used singly or in combination of two or more kinds.

The mixing ratio of these fillers should preferably be at most 40 g (not more than 40 g) per 100 g of the aforementioned component (A) provided that the aforementioned components (F) to (H) are not employed, or at most 40 g per 100 g of a total of the aforementioned components (A) and (F) provided that both these components (A) and (F) are employed. If the mixing ratio of these fillers is excessive, it may become difficult to form an island structure after the aforementioned surface-roughening treatment, thus deteriorating the adhesion of the plated metal film.

In addition to aforementioned additives, it is also possible to co-use a known coloring pigment such as an organic pigment such as phthalocyanine-based pigments (phthalocyanine green, phthalocyanine blue, etc.), azo-based pigments, and an inorganic pigment such as titanium dioxide. Furthermore, the curable resin composition may contain a leveling agent such as silicone compounds, acrylate copolymer, fluorinated surfactant, etc., an adhesion-imparting agent such as silane coupling agent; a thixotropic agent such as aerogel; a dispersion stabilizing agent such as various kinds of surfactant and macromolecular dispersing agent; an antifoaming agent; an anti-oxidant; a flame retardant such as bromine-based compounds, phosphorus-based compounds and antimony-based compounds; and an auxiliary agent constituted by a rubber material such as polybutadiene which is designed to be used for the surface-roughening by making use of permanganate solution.

The aforementioned components (A) and (B), and if desired, the aforementioned optional components (C), (D), (E) and also the aforementioned organic solvent as well as various kinds of additives are mixed together at a predetermined ratio and stirred to obtain a mixed solution, which is further subjected, if the mixed solution contains solid particles which can be hardly dispersed, to a dispersing treatment to thereby sufficiently disperse the solid particles by making use of a three-roll mill for example (if the resin composition contains a reactive diluent, the dispersing treatment is performed before incorporating this reactive diluent into the resin composition to thereby suppress the photo-setting reaction during the dispersion treatment) to prepare a homogeneous solution or dispersion. When the concentration of solid matters (the concentration of nonvolatile matters) in the resin composition is about 40 to 80%, the viscosity of the resin composition (25° C.) should preferably be confined within the range of 0.5 to 300 dPa·s.

If an interlayer insulating film for multi-layer printed wiring board is to be formed, a curable resin composition useful for coating (a curable thermosetting resin composition or a photo-sensitive/thermosetting resin composition) to be obtained as described above according to the present invention is coated on the surface of a printed wiring board having a first conductive pattern which has been formed through the etching of copper foil of a copper-clad laminate (a first layer) for example to thereby form a filmy coating having a thickness (liquid film thickness) ranging from about 10 to 150 μm by-means of a screen printing method, an electrostatic coating method, a roll coater method, a curtain coater method, etc. Thereafter, the filmy coating is subjected to a heat treatment for about 15 to 60 minutes at a temperature preferably ranging from 90 to 180° C., if the curable resin composition is constituted by the aforementioned components (A) and (B), and optionally, the aforementioned components (C), (D), (E) and also the aforementioned solvent to thereby form a cured film, or subjected to a heat treatment for about 15 to 60 minutes at a temperature preferably ranging from 60 to 80° C. to thereby permit the solvent to volatilize, which is followed by the photo-curing of the filmy coating through the irradiation of ultraviolet rays and then, a post curing for 10 to 60 minutes at a temperature ranging from 140 to 160° C. by means of a hot air circulating type drier, etc., if the photo-sensitive/thermosetting resin composition is constituted by the aforementioned components (A) to (H). The cured film thus obtained is then subjected to the irradiation of laser beam or to the application of drilling to thereby form via-holes at predetermined positions of the cured film, thus forming a via-hole pattern having these via-holes arranged at desired positions. In the case of the resin composition constituted by the aforementioned components (A) to (H), the via-hole pattern can be formed also by means of a photographic developing method. Thereafter, the resultant cured film is subjected to a surface-roughening treatment by making use of a permanganate solution, etc. to obtain a surface-roughened cured film, which is then subjected to a nonelectrolytic metal plating, which is followed by an electrolytic metal plating. By the way, these nonelectrolytic metal plating and electrolytic metal plating may not be confined to copper plating but may be performed using other kinds of metals such as nickel.

Then, a dry film (a film formed of a semi-cured photosensitive resin film) which is proposed by the present invention or commonly employed is stuck onto the surface of the plated metal film. Alternatively, a photosensitive/thermosetting resin composition useful for coating according to the present invention is coated on the surface of the plated metal film. Then, after a negative film having a desired conductive pattern is superimposed on the dry film or on the filmy coating, the dry film or filmy coating is subjected to an exposure using ultraviolet rays and then, to a development to thereby partially expose the plated metal film, the exposed portion of which being subsequently etched away by making use of a chemical such as a solution of copper(II) chloride. Thereafter, the residual portion of the cured film is immersed in a dilute alkaline solution and scraped away to form a second conductive pattern constituted by the plated metal film. As a result, the first conductive pattern of the printed wiring board is enabled to electrically connect with the second conductive pattern by way of a conductive body (via contact) constituted by the plated metal film that has been deposited on the inner wall of the via hole, thus forming an electronic circuit wherein the conductive pattern of the first layer is electrically connected with the conductive pattern of the second layer.

It is possible in this manner to provide the printed wiring board with a second conductive pattern through an interlayer insulating film constituted by a cured film. Likewise, the printed wiring board can be further provided with a third interlayer insulating film and a third conductive pattern through this second conductive pattern disposed on the interlayer insulating film. This procedure can be repeated a required number of times. As for the outermost interlayer insulating film, the following procedures can be performed. Namely, a solder resist ink which is commonly employed or which is constituted by photosensitive/thermosetting resin composition useful for coating according to the present invention is coated all over the surface including the conductive pattern disposed on the outermost interlayer insulating film, and this coated ink layer is then heated at a temperature ranging from 60 to 80° C. for about 15 to 60 minutes to volatilize the solvent, thereby drying this coated ink layer. Subsequently, a negative film (a negative film patterned so as to enable ultraviolet rays to pass therethrough except the soldering land portions to which electronic parts are subsequently reflow-soldered) is superimposed on this coated ink layer that has been dried as described above, and ultraviolet rays are irradiated all over the negative film. Subsequently, this negative film is removed, and the non-exposure regions corresponding to the soldering land portions are removed by making use of a dilute aqueous alkaline solution to thereby performing the development of the filmy coating. Then, the resultant film is subjected to a post curing for 10 to 60 minutes by making use of a hot air-circulating type drier which is designed to produce a hot air of 140 to 160%, thus forming an aimed solder resist film.

It is possible in this manner to obtain a multi-layer printed wiring board having a solder resist film covered thereon. Thereafter, electronic components are mounted on this multi-layer printed wiring board by means of a jet soldering method or a reflow soldering method, thereby fixing and electrically connecting these electronic components to the printed wiring board, thus forming one electronic circuit unit.

Therefore, the present invention includes in its scope not only a multi-layer printed wiring board having a solder resist film covered thereon before this wiring board is mounted with electronic components, but also a multi-layer printed wiring board having electronic components mounted thereon.

The present invention also includes, in its scope, printed wiring boards having a conductive pattern covered with a solder resist film at the outermost layer with or without electronic components being mounted thereon, which can be obtained by performing the same procedures as mentioned above on the ordinary printed wiring board constituted by a single layer of conductive pattern so as to cover the conductive pattern with the solder resist film prior to the mounting of the electronic components, or so as to reflow-solder the electronic components.

Further, the present invention also provides a dry film which is designed to be stuck onto a plated metal film for forming a conductive pattern as mentioned above, a dry film having the aforementioned solder resist film formed thereon, and a dry film having the aforementioned interlayer insulating film formed thereon. The manufacture of these dry films can be performed as follows. Namely, a thermosetting resin composition or a photosensitive/thermosetting resin composition useful for coating according to the present invention is formulated so as to adjust the concentration of solid matters to about 40 to 60 mass %, and then, by making use of a die coater, either one of the thermosetting resin compositions is coated on a polyethylene terephthalate film (PET film) which is coated in advance, if required, with a mold-releasing agent or subjected to a mold-releasing treatment to thereby form a coated layer having a thickness (liquid film thickness) ranging from about 10 to 150 μm. Thereafter, the coated layer is dried for 5 to 30 minutes at a temperature ranging from 90 to 140° C. when the coated layer is constituted by a thermosetting resin composition useful for coating (these drying conditions may be the same even when the coated layer is constituted by a photosensitive/thermosetting resin composition useful for coating), thereby adjusting the concentration of the residual solvent in the filmy coating to 2 to 10 mass %, thus producing the dry film constituted by a semi-cured filmy coating. On this occasion, a polyethylene film may be superimposed as a parting film on one surface of the dry film to form a laminate, which is then wound up for shipment, this polyethylene film being subsequently peeled away to permit said one surface of the dry film to expose in the use thereof.

The dry film which is constituted by a semi-cured filmy coating and lined with a polyethylene film is constructed so as to be stuck onto the surface of a printed wiring board or of an interlayer insulating film depending on the end-use thereof by taking advantage of the adhesive force of the dry film. On this occasion, the lamination of the dry film should preferably be performed by means of a vacuum laminator. The polyethylene terephthalate is subsequently peeled away. In the case where an interlayer insulating film is formed in the manufacture of a multi-layer printed wiring board, the surface to be covered with the interlayer insulating film is constituted by a printed wiring board or by another interlayer insulating film. In any case, the dry film is formed by making use of the aforementioned thermosetting resin composition and heat-treated for 15 to 60 minutes at a temperature ranging from 130 to 180° C. to thereby form a cured film. The formation of via-hole, etc. thereafter can be performed in the same manner as mentioned above. Further, even in the cases where a solder resist film is to be formed over the conductive pattern constituting the outermost layer of multi-layer printed wiring board, where a solder resist film is to be formed on the surface of an ordinary single-layer printed wiring board, or where an interlayer insulating film is to be formed for the manufacture of the multi-layer printed wiring board, the dry film is produced by making use of a photosensitive/thermosetting resin composition useful for coating according to the present invention, and the resultant dry film that has been stuck as described above is then successively subjected to the photocuring and heat-curing in the case of forming an interlayer insulating film, which is followed by the same treatments as illustrated in the case of forming the filmy coating in the formation of a solder resist film.

It should be noted that the present invention is intended to cover broader concepts with respect to each of the components and to the ratios thereof centering on those employed in the following Examples, so that the employment of analogous compounds to those described above at the aforementioned preferable ranges in ratio of these compounds is possible in the present invention.

### EXAMPLES

Next, the present invention will be further explained with reference to the following examples, which are not intended to limit the present invention.

### Synthesis Example 1

### Synthesis of Multi-Functional Vinylbenzyl Ether for EXAMPLES

112 g (0.8 equivalent weight) of alkylphenol novolac resin (“HE-100C” (trade name), Sumitomo Chemicals Co., Ltd.), and 45 g (0.8 equivalent weight) of potassium hydroxide were dissolved in 200 g of dimethyl sulfoxide and 30 g of water to obtain a mixed solution. Further, 124 g (0.8 equivalent weight) of chloromethyl styrene and 0.1 g of hydroquinone were dissolved in 100 g of dimethyl sulfoxide to obtain a solution, which was then dropped into the aforementioned mixed solution over one hour at a temperature of 70° C. The resultant solution was then permitted to take place a reaction therein for two hours at a temperature of 70° C.

Next, an excessive quantity of water was added to the aforementioned reaction system and after the stirring thereof, benzene was added to the resultant reaction system to extract extractable matters. The benzene phase was washed away by making use of 5% caustic potash, and the washing with water of the benzene phase was repeated until the pH of the aqueous phase became 7. Thereafter, the benzene phase was permitted to dry by making use of anhydrous sodium sulfate. After the removal of benzene, recrystallization was performed with the employment of ethanol (yield: 85%) to obtain multi-functional vinylbenzyl ether represented by the following chemical formula (3).

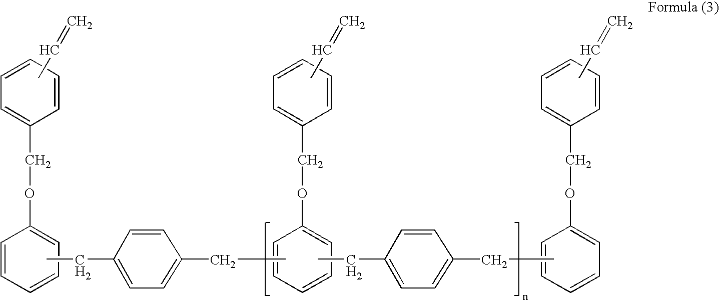

Wherein n is 3-7 in average.

### Synthesis Example 2

### Synthesis of Vinylbenzyl Ether for Comparative Examples

92 g (0.8 equivalent weight) of bisphenol, and 45 g (0.8 equivalent weight) of potassium hydroxide were dissolved in 200 g of dimethyl sulfoxide and 30 g of water to obtain a mixed solution. Further, 124 g (0.8 equivalent weight) of chloromethyl styrene and 0.1 g of hydroquinone were dissolved in 100 g of dimethyl sulfoxide to obtain a solution, which was then dropped into the aforementioned mixed solution over one hour at a temperature of 70° C. The resultant solution was then permitted to take place a reaction therein for two hours at a temperature of 70° C.

Next, an excessive quantity of water was added to the aforementioned reaction system and after the stirring thereof, benzene was added to the resultant reaction system to extract extractable matters. The benzene phase was washed away by making use of 5% caustic potash, and the washing with water of the benzene phase was repeated until the pH of the aqueous phase became 7. Thereafter, the benzene phase was permitted to dry by making use of anhydrous sodium sulfate. After the removal of benzene, recrystallization was performed with the employment of ethanol (yield: 90%) to obtain vinylbenzyl ether represented by the following chemical formula (4).

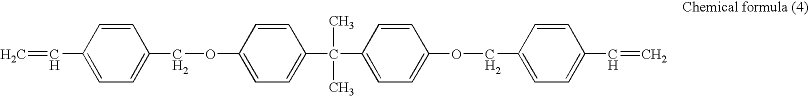

### Example 1

(Preparation of Thermosetting Resin Composition Useful for Coating):

70 g of the multi-functional vinylbenzyl ether obtained in the synthesis example 1 was mixed with and dissolved in a mixed solvent consisting of 15 g of Solvesso #150 (an aromatic solvent, Shell Kagaku Co., Ltd.) and 15 g of carbitol acetate to obtain a mixed solution.

Then, 10 g of magnesium hydroxide was added to the aforementioned mixed solution with stirring to obtain a mixture, to which 1 g of Modaflow (a leveling agent, Monsant Co., Ltd.) was further added to obtain a mixture. Thereafter, 0.5 g of Perbutyl Z (a radical polymerization initiator, Nippon Oil & Fats Co., Ltd.) was added to the mixture and stirred for 20 minutes.

Then, the resultant mixture thus obtained was further mixed for 30 minutes by making use of a three-roll mill to thereby prepare a thermosetting resin composition useful for coating.

The specific components of this thermosetting resin composition useful for coating are shown in Table 1.

(Manufacture of a Multi-Layer Printed Wiring Board):

An etching treatment was performed on the surface of copper foil formed on the surface of a substrate (a first layer) so as to form a first conductive pattern of a printed wiring board. Then, the resultant wiring board having a first conductive pattern formed thereon was subjected to pretreatments comprising the steps of degreasing, soft etching, blackening treatment, washing and drying to thereby produce a surface-treated printed wiring board, onto which the aforementioned thermosetting resin composition useful for coating was coated by means of screen printing to form a layer of the thermosetting resin composition thereon. Subsequently, the layer of the thermosetting resin composition useful for coating was subjected to heat-curing treatment for 30 minutes at a temperature of 170° C. to form a cured coat film (interlayer insulating film, i.e. a second layer) having a thickness of 60 μm.

Via holes each having a diameter of 150 μm were formed in this interlayer insulating film at a density of 100 per 10 mm² by making use of laser to thereby form a via-hole pattern at a desired region of this interlayer insulating film. Then, this interlayer insulating film was subjected to a surface-roughening treatment (a treatment wherein the surface of cured film was dipped in MLB Promotor 213 (sodium permanganate treating solution, Shipray Co., Ltd.) for 10 minutes at a temperature of 80° C.) and washed with water, which was followed by a neutralization treatment (a treatment wherein the surface of cured film was dipped in MLB Neutraliser 216 (a neutralizing solution, Shipray Co., Ltd.) for 5 minutes at a temperature of 50° C.).

Thereafter, this interlayer insulating film was subjected to a degreasing treatment (a treatment wherein the interlayer insulating film was dipped in Neutraliser 3230 (Shipray Co., Ltd.) for 5 minutes at a temperature of 40° C.) and to a catalyst-providing treatment (a treatment wherein the interlayer insulating film was dipped in Cataposit 44 (Shipray Co., Ltd.) for 5 minutes at a temperature of 40° C.), which was followed by an electroless copper plating treatment (a treatment wherein the interlayer insulating film was dipped in Cuposit 328 (Shipray Co., Ltd.) for 20 minutes at a temperature of 23° C.). Furthermore, this plated film was subjected to an electrolytic copper plating (by making use of copper sulfate) to allow a film of plating to deposit to a thickness of 25 μm. The film of plating thus obtained was then subjected to annealing (150° C., for one hour). As a result, it was possible to obtain a printed wiring board provided with an interlayer insulating film having a film of copper plating deposited thereon.

Then, this printed wiring board provided with a film of copper plating was treated as follows. Namely, a dry film available in market (Sunford AQ (a film having a thickness of 38 μm and formed of a semi-cured photosensitive resin film), Asahi Kasei Industries Ltd.) was laminated on this film of copper plating by means of a roller laminator to enable the dry film to be fixed to the film of copper plating by the effect of adhesive force of the dry film. Thereafter, a negative film having a desired conductive pattern of electronic circuits was superimposed on this dry film, and the dry film was subjected to an exposure using ultraviolet rays and then, to a development to thereby partially expose the film of copper plating, this exposed portion being subsequently etched away by making use of a chemical such as a solution of copper(II) chloride. Thereafter, the residual portion of the dry film which was cured by the irradiation of ultraviolet rays was immersed in an alkaline solution and scraped away to form a second conductive pattern constituted by the film of copper plating. As a result, it was possible to electrically interconnect the first conductive pattern with the second conductive pattern by way of a conductive body (via contact) constituted by the film of copper plating that had been deposited on the inner wall of each of the via holes.

It is possible in this manner to deposit a second conductive pattern on an interlayer insulating film (a second layer) constituted by a cured film. Likewise, it is possible to deposit a third interlayer insulating film and a third conductive pattern over the interlayer insulating film (a second layer). This procedure can be repeated a required number of times. As for the outermost insulating film, the following procedures can be performed. Namely, a solder resist ink which is available in market (DSR-2200BGX5, Tamura Kaken Co., Ltd.) is coated all over the surface including the conductive pattern disposed on the outermost insulating film, and this coated ink layer is then heated at a temperature of 80° C. for about 20 minutes to volatilize the solvent, thereby drying this coated ink layer. Subsequently, a negative film (a negative film patterned so as to enable ultraviolet rays to pass therethrough except the soldering land portions to which electronic parts are subsequently reflow-soldered) is superimposed on this coated ink layer that has been dried as described above, and ultraviolet rays are irradiated all over the negative film. Subsequently, this negative film is removed, and the non-exposure regions corresponding to the soldering land portions are removed by making use of a dilute aqueous alkaline solution such as a 0.5-5 mass % aqueous solution of sodium carbonate to thereby performing the development of the filmy coating. Then, the resultant film is subjected to a post curing for 60 minutes by making use of a hot air-circulating type drier which is designed to produce a hot air of 150° C., thus forming an aimed solder resist film It is possible in this manner to obtain a multi-layer printed wiring board having a solder resist film covered thereon. Thereafter, electronic components are mounted on this multi-layer printed wiring board by means of a jet soldering method or a reflow soldering method, thereby fixing and electrically connecting these electronic components to the printed wiring board, thus forming one electronic circuit unit.

(Evaluation of the Properties)

The examinations were performed on the following items, the results being shown in Table 2.

(1) The Adhesivity of the Film of Copper Plating:

Based on JIS C6481, a printed wiring board having a film of copper plating formed thereon was employed as a test piece, and a tip end of the film of copper plating (10 mm in width) which was partially peeled of f was gripped and pulled apart from the printed wiring board by making use of a gripper in such a manner that the pulling direction thereof was kept perpendicular to the plane of the film of copper plating so as to determine the peeling strength (kN/m) on this occasion.

(2) Relative Permittivity and Dielectric Loss Tangent:

The aforementioned thermosetting resin composition useful for coating was coated on the surface of Teflon (trade mark) plate and allowed to cure to form a cured film. Thereafter, the cured film was peeled away from the Teflon plate and cut into a piece having a size of 30 mm×30 mm×1 mm, thus preparing a test piece. This test piece was then measured with respect to the relative permittivity and dielectric loss tangent thereof at 1 GHz by making use of an impedance analyzer HP4291 (Adirent Technology Co., Ltd.) as a measuring apparatus.

(3) Moisture Resistance:

A printed wiring board provided with an interlayer insulating film (a second layer) constituted by the aforementioned cured film was employed as a test piece, and this test piece was placed inside a pressure cooker and left to stand for 200 hours in an atmosphere of: 121° C. in temperature, 2 atm. in pressure, and 100% in relative humidity. Then, the state of the interlayer insulating film was visually evaluated according to the following criteria.

⊚ There was no change in the state thereof.

◯ There was recognized slight changes in the state thereof.

Δ There was recognized prominent changes in the state thereof.

X The filmy coating was swelled and peeled.

(4) Soldering Heat Resistance:

A printed wiring board provided with an interlayer insulating film (a second layer) constituted by the aforementioned cured film was employed as a test piece, and this test piece was evaluated according to the testing method set forth in JIS C 6481. Namely, the test piece was immersed for 30 seconds in a solder tank maintained at a temperature of 260° C. Then, a cycle of peeling test using a Cellophane (tradename) adhesive tape was repeated up to three times to evaluate the condition of the filmy coating by way of visual observation according to the following criteria.

⊚ There was no change in the filmy coating even after three cycles of peeling test.

◯ There was recognized slight changes in the filmy coating after three cycles of peeling test.

Δ There was recognized changes in the filmy coating after two cycles of peeling test.

X There was recognized the peeling of the filmy coating after one cycle of peeling test.

(5) Solvent Resistance:

A printed wiring board provided with an interlayer insulating film (a second layer) constituted by the aforementioned cured film was employed as a test piece, and this test piece was immersed in methylene chloride at normal temperature for 30 minutes. Then, the state of the interlayer insulating film was visually evaluated according to the following criteria.

⊚ There was no change in the state thereof.

◯ There was recognized slight changes in the state thereof.

Δ There was recognized prominent changes in the state thereof.

X The interlayer insulating film was swelled and peeled.

(6) Insulation Resistance:

A printed wiring board provided with an interlayer insulating film (a second layer) constituted by the aforementioned cured film was employed as a test piece. Then, a DC voltage of 50V was applied to the printed wiring board in an atmosphere of: 85° C. in temperature and 85% in relative humidity by making use of a tandem electrode of IPC SM-840B B-25 test coupon of IPC-TM-650 to thereby measure the insulation resistance 500 hours later.

### Example 2

A thermosetting resin composition useful for coating and constituted by the components shown in Table 1 was prepared by repeating the same procedures as explained in Example 1, except that 20 g out of 70 g of the multi-functional vinylbenzyl ether represented by the chemical formula (3) was replaced by “Epichlon 1050” (bisphenol A epoxy resin (thermosetting epoxy resin), Dainippon Ink & Chemicals Inc.), and that 5 g of Phenolite TD2090 (bisphenol novolac resin (curable epoxy compound), Dainippon Ink & Chemicals Inc.) and 0.5 g of dicyan diamide (curable epoxy compound) were additionally employed. Then, a multi-layer printed wiring board was prepared by making use of the aforementioned thermosetting resin composition, and the performance tests were performed in the same manner as described in Example 1, the results being shown in Table 2.

### Comparative Example 1

A thermosetting resin composition constituted by the components shown in Table 1 was prepared by repeating the same procedures as explained in Example 1, except that vinylbenzyl ether represented by the chemical formula (4) was substituted for the compound represented by the chemical formula (3). Then, a multi-layer printed wiring board was prepared by making use of the aforementioned thermosetting resin composition, and the performance tests were performed in the same manner as described in Example 1, the results being shown in Table 2.

### Comparative Example 2

A thermosetting resin composition useful for coating and constituted by the components shown in Table 1 was prepared by repeating the same procedures as explained in Example 1, except that the compound represented by the chemical formula (3) was replaced by 60 g of Epichlon 1050, 15 g of Phenolite TD2090 and 1.5 g of dicyan diamide, and that perbutyl Z was not employed. Then, a multi-layer printed wiring board was prepared by making use of the aforementioned thermosetting resin composition, and the performance tests were performed in the same manner as described in Example 1, the results being shown in Table 2.

### Example 3

(Preparation of Photosensitive/Thermosetting Resin Composition Useful for Coating):

Cresol novolac epoxy resin (epoxy equivalent: 220) having seven phenol residual groups in average per molecule and epoxy group was allowed to react with acrylic acid at a molar ratio of 1:1 in ethylcarbitol acetate to obtain a reaction product. Then, this reaction product was allowed to react with anhydrous teterahydrophthalic acid at a molar ratio of 1:0.6 to obtain a solution of photosensitive resin (F). This solution of photosensitive resin was formed of a viscous liquid comprising 50 parts by mass of ethylcarbitol acetate per 100 parts by mass of resinous components constituting solid matters, the acid value of the resinous components being 88 mgKOH/g.

To 55 g of this solution of photosensitive resin (F) were added 60 g of multi-functional vinylbenzyl ether, 1 g of dicyan diamide, 22 g of the aforementioned YX-4000, 4 g of dipentaerythritol hexaacrylate, 5 g of 2-methyl-1-[4-(methylthio)phenyl]-2-morpholino-1-propan-1-one, 1 g of 2,4-diethylthioxanthone, and log of magnesium hydroxide to a mixture, which was then mixed and dispersed by making use of a three-roll mill to thereby prepare a photosensitive/thermosetting resin composition useful for coating, the specific components of which being shown in Table 1.

(Manufacture of a Multi-Layer Printed Wiring Board, and the Evaluation of the Performance Thereof):

A printed wiring board was manufactured in the same manner as described in Example 1 except that the photosensitive/thermosetting resin composition useful for coating that had been prepared as described above was substituted for the thermosetting resin composition for the formation of an interlayer insulating film as explained below. Namely, a film coated of this resin composition (35 μm in thickness before drying) was allowed to dry for 20 minutes at a temperature of 80° C. (to an extent where the film was no longer sticky even if it was touched with one's finger), this dried film was irradiated through a negative film with ultraviolet rays to photo-cure the dried film, this cured film was subjected to the development thereof by making use of 1% solution of Na₂CO₃ to form a via-hole pattern, and the resultant film was permitted to thermally cure for 60 minutes at a temperature of 150° C. to obtain a cured film constituting the interlayer insulating film. Then, the evaluation of the performance of this multi-layer printed wiring board was performed in the same manner as described in Example 1, the results being shown in Table 2.

### Comparative Example 3

A thermosetting resin composition constituted by the components shown in Table 1 was prepared by repeating the same procedures as explained in Example 3, except that the compound represented by the aforementioned chemical formula (3) was not employed at all. Then, a multi-layer printed wiring board was prepared by making use of the aforementioned thermosetting resin composition, and the performance tests were performed in the same manner as described in Example 1, the results being shown in Table 2.

### Example 4

(Manufacture of a Printed Wiring Board Covered with a Solder Resist Film):

An etching treatment was performed on the surface of copper foil formed on the surface of a substrate (a first layer) so as to form a first conductive pattern of a printed wiring board. Then, the resultant wiring board having a first conductive pattern formed thereon was subjected to pretreatments comprising the steps of degreasing, soft etching, blackening treatment, washing and drying to thereby produce a surface-treated printed wiring board, onto which the aforementioned photosensitive/thermosetting resin composition useful for coating (however, it contained 1 g of phthalocyanine green, and the resultant mixture was blended and mixed using a three-roll mill) was coated by means of screen printing to form a layer of the thermosetting resin composition (35 μm in thickness before drying) thereon. Subsequently, the layer of this resin composition was allowed to dry for 20 minutes at a temperature of 80° C.

Then, after a negative was closely superimposed on this coated surface of the substrate, the coated surface was subjected to an exposure and then, to a development using a 1 mass % aqueous solution of sodium carbonate to thereby form a pattern in this filmy coating. Then, the resultant substrate was thermally cured at a temperature of 150° C. for 60 minutes to obtain a printed wiring board having a solder resist film constituted by a cured film.

(Evaluation of the Performance of the Solder Resist Film)

(1) Dry to Touch:

The surface of the dried film was permitted to lightly touch with one's finger before a negative film was adhered onto the surface of the dried film to thereby examine the tackiness of the dried film to one's finger, thus evaluating it according to the following criteria.

⊚ The adhesion of the dried film to one's finger was not recognized at all.

◯ The adhesion was not substantially recognized.

Δ A trace of adhesion was recognized.

X There was recognized the adhesion of the dried film to one's finger.

(2) Sensitivity:

A step tablet (Kodak 21 steps) for measuring the sensitivity was disposed on the surface of the dried film before the aforementioned negative film was closely superimposed thereon. Thereafter, through this step tablet, an ultraviolet ray having a main peak wavelength of 365 nm was irradiated onto the surface of the dried film so as to control the exposure dose thereof to 300 mJ/cm² (as measured using an integrating dosimeter manufactured by Oak Seisakusho Co., Ltd.) to thereby obtain a test piece. Then, the development of the test piece was performed for 60 seconds by making use of 1% aqueous solution of sodium carbonate and at a spray pressure of 2.0 kg/cm². Then, the sensitivity of the dried film was evaluated according to a method wherein the portions which were subjected to the aforementioned irradiation but were still left unremoved were represented by the number (the step number) (larger the step number is, the more excellent the photosensitivity of the dried film is).

(3) Gold-Plating Resistance:

In order to examine the resistivity of the solder resist film against the nonelectrolytic plating, the test pieces each constituted by a printed wiring board having the aforementioned solder resist film formed thereon were subjected to a gold-plating work (by making use of a nonelectrolytic nickel plating bath and nonelectrolytic gold plating bath both available in market, the plating was performed under the conditions of: nickel, 0.5 μm; and gold, 0.03 μm). Then, a peeling test using a Cellophane adhesive tape was performed through the observation of the peeling and discoloration of the solder resist film, thereby evaluating the gold-plating resistance thereof according to the following criteria.

⊚ There was no change in the solder resist film.

◯ There was recognized slight changes in the solder resist film.

Δ There was recognized prominent changes in the solder resist film.

X The solder resist film was swelled and peeled.

(4) Adhesivity:

The adhesivity of the test piece was measured by way of a cross-cut adhesion test based on JIS D-0202.

(5) Pencil Hardness:

The solder resist film was evaluated based on JIS K-5400 6.14.

(6) Acid Resistance:

A printed wiring board provided with the aforementioned solder resist film was employed as a test piece, and this test piece was immersed for 30 minutes in 10 mass % aqueous solution of sulfuric acid. Then, after being water-washed, a peeling test using a Cellophane adhesive tape was performed to evaluate the acid resistance of the solder resist film through the observation of the peeling and discoloration thereof according to the following criteria.

⊚ There was no change in the solder resist film.

◯ There was recognized slight changes in the solder resist film.

Δ There was recognized prominent changes in the solder resist film.

X The solder resist film was swelled and peeled.

(7) Solvent Resistance:

The method of this test was the same as the solvent resistance test performed in Example 1.

(8) Soldering Heat Resistance:

The method of this test was the same as the soldering heat resistance test performed in Example 1.

(9) Electric Properties (Insulation Resistance and Discoloration):

A printed wiring board provided with the aforementioned solder resist film was employed as a test piece. Then, a DC voltage of 50V was applied to the printed wiring board in a thermo-hygrostat under the conditions of: 85° C. in temperature and 85% in relative humidity by making use of a tandem coupon of IPC SM-840B B-25 to thereby measure the insulation resistance 500 hours later. At the same time, the discoloration of the solder resist film was observed to visually evaluate the degree of discoloration according to the following criteria.

⊚ There was no change in color in the solder resist film.

◯ There was recognized slight color change in the solder resist film.

Δ There was recognized prominent color change in the solder resist film.

X The solder resist film was burnt black.

### Example 5

(Preparation of a Dry Film and the Employment Thereof):

The thermosetting resin composition useful for coating that had been obtained in Example 1 was coated, by means of die coater (deliverying forward) on a polyethylene terephthalate film (38% m in thickness) which was coated in advance with a mold-releasing agent to thereby form a coated layer having a thickness of about 60 μm. Thereafter, the coated layer was dried for 10 minutes at a temperature of 100° C. so as to adjust the concentration of the residual solvent in the filmy coating to 2 to 10 mass %, thereby forming a dry film constituted by a semi-cured filmy coating.

On this occasion, a polyethylene film for example may be superimposed as a parting film on one surface of this dry film to form a laminate, thus enabling it to be shipped in a wound-up state. In the use of this dry film, this polyethylene film is subsequently peeled away to permit said one surface of the dry film to expose in the use thereof, and this exposed surface of the dry film is laminated, by means of a vacuum laminator, on the surface of any desired substrate (for example, the upper surface of a first printed wiring board in the manufacturing process of a multi-layer printed wiring board, the upper surface of an interlayer insulating film provided with a conductive pattern, or the upper surface of a single-ply printed wiring board). Thereafter, the polyethylene terephthalate film is peeled away, and then, as in the case of the aforementioned filmy coating or dry film, the semi-cured film is thermally cured to thereby form an interlayer insulating film, a solder resist film, a film for etching, etc.

TABLE 1

| | Example | | | | Comp. Ex. | | |
|---|---|---|---|---|---|---|---|
| | 1 | 2 | 3 | 4 | 1 | 2 | 3 |
| Multi-functional | 70 | 50 | 60 | 60 | | | |
| vinyl ether | | | | | | | |
| (formula 3) | | | | | | | |
| Vinyl ether | | | | | 70 | | |
| (formula 4) | | | | | | | |
| Epichlon 1050 | | 20 | | | | 60 | |
| Magnesium | 10 | 10 | 10 | 10 | 10 | 10 | 10 |
| hydroxide | | | | | | | |
| Modaflow | 1 | 1 | | | 1 | 1 | |
| Phenolite TD-2090 | | 5 | | | | 15 | |
| Dicyan diamide | 1 | 0.5 | 1 | 1 | 1 | 1.5 | 1 |
| Perbutyl Z | 0.5 | 0.5 | | | 0.5 | | |
| Solvesso #150 | 15 | 15 | | | 15 | 15 | |
| Carbitol acetate | 15 | 15 | | | 15 | 15 | |
| Solution of | | | 55 | 55 | | | 55 |
| photosensitive | | | | | | | |
| resin | | | | | | | |
| YX-4000 | | | 22 | 22 | | | 22 |
| Dipentaerythritol | | | 4 | 4 | | | 4 |
| hexaacrylate | | | | | | | |
| 2-methyl-1-[4- | | | 5 | 5 | | | 5 |
| (methylthio)phenyl]- | | | | | | | |
| 2-morpholino- | | | | | | | |
| propan-1-one | | | | | | | |
| 2,4- | | | 1 | 1 | | | 1 |
| diethylthio- | | | | | | | |
| xanthone | | | | | | | |
| Phthalocyanine | | | | 1 | | | |
| green | | | | | | | |

Note:
The quantity of these components is represented by “g”.

TABLE 2

| | Example | | | | Comp. Ex. | | |
|---|---|---|---|---|---|---|---|
| | 1 | 2 | 3 | 4 | 1 | 2 | 3 |
| Properties of | | | | | | | |
| interlayer | | | | | | | |
| insulating film | | | | | | | |
| Adhesion of Cu | 1.0 | 0.9 | 0.6 | | 0.4 | 0.3 | 0.3 |
| plating film | | | | | | | |
| (kN/m) | | | | | | | |
| Permittivity | 2.8 | 3.0 | 3.2 | | 3.3 | 4.0 | 4.2 |
| (1 GHz) | | | | | | | |
| Dielectric loss | 0.008 | 0.012 | 0.018 | | 0.033 | 0.038 | 0.038 |
| Tangent (1 GHz) | | | | | | | |
| Moisture | ⊚ | ⊚ | ⊚ | | ⊚ | ⊚ | ⊚ |
| Resistance | | | | | | | |
| Soldering heat | ⊚ | ⊚ | ⊚ | | ⊚ | ⊚ | ⊚ |
| Resistance | | | | | | | |
| Solvent | ⊚ | ⊚ | ⊚ | | ⊚ | ⊚ | ⊚ |
| Resistance | | | | | | | |
| Insulation | 3.0 | 4.0 | 4.0 | | 3.0 | 3.0 | 4.0 |
| Resistance | | | | | | | |
| (× 10¹²Ω) | | | | | | | |
| Properties of | | | | | | | |
| solder resist film | | | | | | | |
| Sensitivity | | | | 8 | | | |
| Dry to touch | | | | ⊚ | | | |
| Gold-plating | | | | ⊚ | | | |
| Resistance | | | | | | | |
| Adhesivity | | | | ◯ | | | |
| Pencil hardness | | | | 6H | | | |
| Acid resistance | | | | ◯ | | | |
| Solvent | | | | ⊚ | | | |
| Resistance | | | | | | | |
| Soldering heat | | | | ⊚ | | | |
| Resistance | | | | | | | |
| Electric | | | | | | | |
| Properties | | | | | | | |
| Insulation | | | | 4.0 | | | |
| Resistance | | | | | | | |
| (× 10¹²Ω) | | | | | | | |
| Discoloration | | | | ◯ | | | |

It will be recognized from the results of Table 2 that with respect to the interlayer insulating films obtained in Examples 1 to 3 where the aforementioned compound represented by the formula (3), those obtained in of Examples 1 and 2 were more excellent in the adhesion of copper plating film, in permittivity and in dielectric loss tangent as compared with that of Example 3. Further, as compared with the interlayer insulating films of Comparative Examples 1 to 3 where the compound represented by the formula (3) was not employed, those obtained in of Examples 1 and 2 were at least twice more excellent regarding the adhesion of copper plating film, at least about 10% more excellent regarding the permittivity (Example 2 and Comparative Example 1), and at least about 2.8 times more excellent regarding the dielectric loss tangent (Example 2 and Comparative Example 1). Additionally, the film obtained in Example 4 was excellent also as a solder resist film.

According to the present invention, it is possible to provide a cured film, which is excellent in minimizing not only the dielectric constant but also the dielectric loss tangent thereof, and also excellent in workability and in adhesivity to a plated copper film, thus making the copper film difficult to peel off, so that it is only required to partially provide via contact in the surface or inner layer without necessitating any more the provision of a through-hole in the printed wiring board, thus making it possible to prevent the properties of other films of coating from being deteriorated. According to the present invention, it is also possible to provide a curable resin composition which is capable of forming a film and a cured film, which are provided with the aforementioned properties and, at the same time, would not badly affect the photo-curability, exposure, development and other characteristics thereof. This invention also provides a multi-layer printed wiring board which is provided with an interlayer insulating film formed of the aforementioned cured film, a printed wiring board provided with a solder resist film formed of the aforementioned cured film, and a dry film formed of a semi-cured film made from the aforementioned curable resin composition.

The curable resin composition useful for coating as well as the dry film according to the present invention can be used also as an adhesive or as a material for a printing plate.

What is claimed is:

1. A curable resin composition useful for coating, which comprises (A) a polyfunctional vinylbenzyl ether represented by the following general formula (1), and (B) a curing promotor: 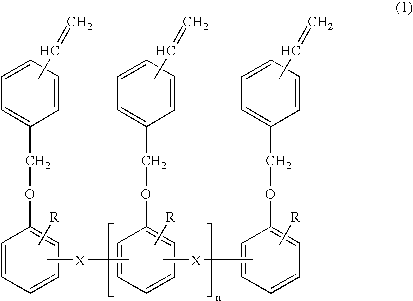
(wherein X denotes —CH₂— or a group represented by the following chemical formula (2); R denotes H or CH₃, wherein Rs each included as a substituent in benzene ring may be the same or different from each other; and n is 0 or an integer larger than 0)

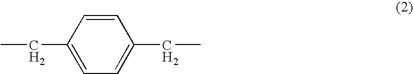

2. A curable resin composition useful for coating, which comprises (A) a polyfunctional vinylbenzyl ether represented by the general formula (1) set forth in claim 1, (D) a thermosetting epoxy resin, (E) an epoxy-curable compound, (G) a photopolymerization initiator, and (H) a diluent.

3. The curable resin composition useful for coating according to claim 1, wherein said curing promotor (B) is incorporated at a ratio of 0.01 to log per 100 g of said polyfunctional vinylbenzyl ether (A).

4. A multi-layer printed wiring board which is provided with an interlayer insulating film formed of a cured film which is constituted by the curable resin composition useful for coating as claimed in claim 1.

5. A multi-layer printed wiring board which is provided with an interlayer insulating film formed of a cured film which is constituted by the curable resin composition useful for coating as claimed in claim 2.

6. A multi-layer printed wiring board which is provided with an interlayer insulating film formed of a cured film which is constituted by the curable resin composition useful for coating as claimed in claim 3.

7. A printed wiring board which is provided with a solder resist film formed of a cured film which is formed by making use of the curable resin composition useful for coating as claimed in any one of claim 1.

8. A printed wiring board which is provided with a solder resist film formed of a cured film which is formed by making use of the curable resin composition useful for coating as claimed in any one of claim 2.

9. A printed wiring board which is provided with a solder resist film formed of a cured film which is formed by making use of the curable resin composition useful for coating as claimed in any one of claim 3.

10. A dry film which is constituted by a semi-cured filmy coating which is formed on a substrate film through the coating of the curable resin composition useful for coating as claimed in any one of claim 1.

11. A dry film which is constituted by a semi-cured filmy coating which is formed on a substrate film through the coating of the curable resin composition useful for coating as claimed in any one of claim 2.

12. A dry film which is constituted by a semi-cured filmy coating which is formed on a substrate film through the coating of the curable resin composition useful for coating as claimed in any one of claim 3.
